(19) United States
(12) Patent Application Publication
(10) Pub. No.: US 2025/0036993 A1
(43) Pub. Date: Jan. 30, 2025

(54) LARGE LANGUAGE MODELS FOR QUANTUM TRANSPILING

(71) Applicant: SRI International, Menlo Park, CA (US)

(72) Inventors: Adam Derek Cobb, Washington, DC (US); Susmit Kumar Jha, Redwood City, CA (US)

(21) Appl. No.: 18/673,709

(22) Filed: May 24, 2024

Related U.S. Application Data
(60) Provisional application No. 63/468,719, filed on May 24, 2023.

(51) Int. Cl. G06N 10/20; G06N 10/40

(52) U.S. Cl. CPC G06N 10/20; G06N 10/40

(57) ABSTRACT

In an example, a method for training a machine learning model to transpile quantum circuits includes generating, by a quantum circuit generator, a first plurality of quantum circuits according to a general quantum circuit design language, wherein each of the first plurality of quantum circuits comprises a sequence of instructions comprising one or more gates and one or more gate operations; obtaining a second plurality of quantum circuits, wherein each of the second plurality of quantum circuits is transpiled for a target quantum device from a corresponding one of the first plurality of quantum circuits; and training, using the first plurality of quantum circuits and the second plurality of quantum circuits, a machine learning model to transpile a quantum circuit according to the general quantum circuit design language to a quantum circuit for the target quantum device.

This application claims the benefit of U.S. Patent Application 63/468,719, filed May 24, 2023, which is incorporated by reference herein in its entirety.

### TECHNICAL FIELD

This disclosure is related to quantum programming, and more specifically to large language models for quantum transpiling.

### BACKGROUND

Currently, there are many different types of quantum devices being developed, each with its own strengths and weaknesses. The diversity in quantum devices is expected to increase further as research and investment in quantum technologies grow. While developers design quantum circuits using a broad range of theoretical operations, actual devices may only perform a limited set of gates (basic operations) due to their specific hardware. Transpilation is the process of converting a general quantum circuit designed for an ideal machine into a circuit compatible with limitations of a specific device. Transpilation involves finding equivalent sequences of gates that the device can actually execute.

### SUMMARY

In general, techniques are described for using a Large Language Model (LLM) for quantum circuit transpilation. Transpilation, which is the process of converting from the general design language of quantum circuits to the more device-specific set of circuit operations, is complex and time-consuming. Current transpilation tools rely on pre-programmed rules and algorithms. Conventional transpilation may be computationally expensive, especially for complex circuits. The disclosed techniques replace traditional transpilation tools with a Large Language Models (LLM), specifically transformer-based models. LLMs are adept at learning patterns and relationships in sequences, which may be advantageous because quantum circuits may be represented as sequences of gates. In other words, the disclosed techniques use an LLM specifically for the “language” of quantum circuits. In some examples, the disclosed techniques may leverage a randomized quantum circuit generator to create a training dataset for use in training an LLM.

In some examples, the LLM may be initially trained on simpler circuits with known transpilation rules. Simpler circuits may act as the “curriculum,” providing a foundation for the LLM. Gradually, the training data may incorporate more complex circuits with larger numbers of qubits. Progressive complexity allows the LLM to build upon its knowledge of simpler circuits and extend its capabilities to handle more intricate situations. Simpler circuits may be identified based on a simplicity threshold.

The techniques may provide one or more technical advantages that realize at least one practical application. Transpiling a quantum circuit to a specific quantum device may be time-consuming. By analyzing large amounts of training data (quantum circuits and their transpilations), an LLM could potentially reduce computational cost and increase fidelity compared to traditional approaches. An LLM may learn, using the described techniques, efficient transpilation strategies that are faster than traditional approaches. An LLM applying the described techniques may identify more accurate and error-free ways to translate circuits to real quantum devices, potentially improving the final output quality. An LLM may also learn novel and efficient transpilation strategies not explicitly programmed. As described herein, curriculum learning techniques ensure the LLM builds a strong foundation before tackling complex circuits.

In an example, a method for training a machine learning model to transpile quantum circuits includes generating, by a quantum circuit generator, a first plurality of quantum circuits according to a general quantum circuit design language, wherein each of the first plurality of quantum circuits comprises a sequence of instructions comprising one or more gates and one or more gate operations; obtaining a second plurality of quantum circuits, wherein each of the second plurality of quantum circuits is transpiled for a target quantum device from a corresponding one of the first plurality of quantum circuits; and training, using the first plurality of quantum circuits and the second plurality of quantum circuits, a machine learning model to transpile a quantum circuit according to the general quantum circuit design language to a quantum circuit for the target quantum device.

In an example, a method for transpiling a quantum circuit includes obtaining a first quantum circuit generated according to a general quantum circuit design language; obtaining specific hardware limitations of a target quantum device; and transpiling, using a machine learning model trained to transpile a quantum circuit according to the general quantum circuit design language to a quantum circuit for the target quantum device, the first quantum circuit to a second quantum circuit for the target quantum device.

In an example, a system for training a machine learning model to transpile quantum circuits includes processing circuitry in communication with storage media, the processing circuitry configured to execute a machine learning system configured to: generate, by a quantum circuit generator, a first plurality of quantum circuits according to a general quantum circuit design language, wherein each of the first plurality of quantum circuits comprises a sequence of instructions comprising one or more gates and one or more gate operations; obtain a second plurality of quantum circuits, wherein each of the second plurality of quantum circuits is transpiled for a target quantum device from a corresponding one of the first plurality of quantum circuits; and train, using the first plurality of quantum circuits and the second plurality of quantum circuits, a machine learning model to transpile a quantum circuit according to the general quantum circuit design language to a quantum circuit for the target quantum device.

In an example, a system for transpiling a quantum circuit includes processing circuitry in communication with storage media, the processing circuitry configured to execute a machine learning system configured to: obtain a first quantum circuit generated according to a general quantum circuit design language; obtain specific hardware limitations of a target quantum device; and transpile, using a machine learning model trained to transpile a quantum circuit according to the general quantum circuit design language to a quantum circuit for the target quantum device, the first quantum circuit to a second quantum circuit for the target quantum device.

In an example, non-transitory computer-readable storage media having instructions encoded thereon, the instructions configured to cause processing circuitry to: obtain a first quantum circuit generated according to a general quantum circuit design language; obtain specific hardware limitations of a target quantum device; and transpile, using a machine learning model trained to transpile a quantum circuit according to the general quantum circuit design language to a quantum circuit for the target quantum device, the first quantum circuit to a second quantum circuit for the target quantum device.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 depicts a block diagram of an example configuration for quantum circuit transpiling using LLMs, and execution of the optimized quantum circuit, in accordance with the techniques of the disclosure.

FIG. 2 is a detailed block diagram illustrating an example computing system, in accordance with the techniques of the disclosure.

FIG. 3 is a histogram illustrating transpilation times for a specific quantum computing machine, in accordance with the techniques of the disclosure.

FIG. 4 illustrates examples of a plurality of machine-learning transpiled quantum circuits matching the corresponding quantum circuits transpiled using conventional approaches, in accordance with the techniques of the disclosure.

FIG. 5 is a flowchart illustrating an example mode of operation for a machine learning system, according to techniques described in this disclosure.

Like reference characters refer to like elements throughout the figures and description.

### DETAILED DESCRIPTION

Molecules and subatomic particles follow the laws of quantum mechanics, a branch of physics that explores how the physical world works at the most fundamental levels. At this level, particles behave in strange ways, taking on more than one state at the same time, and interacting with other particles that are very far away. Quantum computing harnesses these quantum phenomena to process information.

The computers we use today are known as classical computers (also referred to herein as “conventional” computers or conventional nodes-“CN”). A conventional computer uses a conventional processor fabricated using semiconductor materials and technology, a semiconductor memory, and a magnetic or solid-state storage device, in what is known as a Von Neumann architecture. Particularly, the processors in conventional computers are binary processors, i.e., operating on binary data represented in 1 and 0.

A quantum processor (q-processor) uses the odd nature of entangled qubit devices (compactly referred to herein as “qubit,” plural “qubits”) to perform computational operations. In the particular realms where quantum mechanics operates, particles of matter can exist in multiple states—such as an “on” state, an “off” state, and both “on” and “off” states simultaneously. Where binary computing using semiconductor processors is limited to using just the on and off states (equivalent to 1 and 0 in binary code), a quantum processor harnesses these quantum states of matter to output signals that are usable in data computing. Herein, a qubit is the physical carrier of quantum information. A qubit is the quantum version of a bit in classical computing, and can have quantum states of |0>, |1>, or the linear combination of both.

Quantum computing can often be used to solve problems more quickly than in conventional computing. For example, one quantum algorithm is Grover's Search, which accomplishes searching through an unordered list of N items with fewer lookups than is the case in conventional computing.

Quantum gates are the elementary building blocks for quantum computation, acting on qubits the way classical logic gates act on bits, one and two at a time, to change qubit states in a controllable way. An X gate inverts the state of a single qubit, much like a NOT gate inverts the state of a single bit in classical computing. An H gate, or Hadamard gate, puts a single qubit into a state of superposition, a combination of the 0 and 1 quantum states. The qubit only resolves to a definite state when measured. For example, when provided with an input having a quantum state of 0, within the Hadamard gate the quantum state is in superposition, but the output has a 50 percent probability of being in the quantum 0 state and a 50 percent probability of being in the quantum 1 state. Other single-qubit gates alter the qubit state in other defined ways.

Multi-qubit gates implement gates that perform conditional logic between qubits, meaning the state of one qubit depends on the state of another. For example, a Controlled-NOT, or CNOT gate, has two qubits, a target qubit and a control qubit. If the control qubit is in the 1 quantum state, the CNOT gate inverts the state of the target qubit. If the control qubit is in the 0 quantum state, the CNOT gate does not change the state of the target qubit.

Multiple qubits can also be entangled. Two or more qubits are entangled when, despite being too far apart to influence one another, they behave in ways that are individually random, but also too strongly correlated to be explained by supposing that each object is independent from the other. As a result, the combined properties of an entangled multi-qubit system can be predicted, but the individual outcome of measuring each individual qubit in such a system cannot.

Similar to conventional computing, quantum computing gates can be assembled into larger groups, called quantum circuits, to perform more complicated operations. For example, a SWAP gate, which exchanges the states of a pair of qubits, can be constructed from three CNOT gates.

Quantum circuits may perform some operations in parallel, and some in series. The length of the longest series in the program is also referred to as the depth of the quantum circuit. For example, the three CNOT gates comprising a SWAP gate are arranged in series, giving a depth of 3. Programs with a shallower depth take less execution time and provide better performance, so are preferred.

Conventional computers do not have to be hand-programmed with specific instruction steps, such as those provided in processor-specific assembly languages. Instead, programmers write hardware-independent code in a higher-level language, and a compiler translates this code into assembly language for execution on a specific processor. Similarly, in quantum computing programmers do not have to specify individual gates. Instead, programmers can write higher-level code in a higher-level language. A compiler parses this code and maps it into a quantum circuit. Finally, a quantum processor executes the quantum circuit. Quantum programmers can also make use of already-programmed libraries, for use in solving problems in areas such as chemistry, artificial intelligence, and optimization.

Compiler optimizations for classical programs, such as classical dataflow based optimizations and stochastic optimizations, do not apply to quantum circuits because outputs from the two types of programs differ. For classical programs, the program state is deterministic, and the output is simply the program state when execution completes. For quantum circuits, the program state represents a probability distribution of all possible outcomes, and the output is merely a sample from the distribution. As a result, outputs change non-deterministically from run to run.

The disclosed techniques recognize that the quantum circuit produced by a compiler is not necessarily the most efficient quantum circuit capable of producing the same result. Just as optimizing compilers optimize compiled code for conventional processors, so too a transpiler is needed to optimize quantum circuits meant to run on quantum processors. As used herein, transpilation refers to transforming a quantum circuit into another quantum circuit that produces the same outputs from the same inputs as does the original quantum circuit. Optimizing refers to refining a quantum circuit so that its execution incurs lower cost, typically by taking less time to execute, better accuracy—e.g., by using a configuration of different or fewer qubits or gates to minimize interference or decoherence, or some combination thereof.

The disclosed techniques may be implemented as a combination of certain q-computing hardware components and a machine learning system. An implementation of the machine learning system portion of the disclosed techniques, or one or more components thereof, may be configured as a modification of an existing classical portion of a hybrid quantum-classical processing environment, as a separate classical computing machine learning system that operates in conjunction with an existing hybrid quantum-classical processing environment, as a standalone machine learning system, or some combination thereof.

Particularly, some illustrative techniques provide a method by which a quantum circuit is transformed, or transpiled, into another quantum circuit having equivalent output, but better performance, than the original.

The disclosed techniques may also store metadata for each of the one or more quantum circuits. Metadata, as used herein, refers to data about the quantum circuit. The metadata may include input and output information about the quantum circuit as well as information produced during the circuit transformation process. For example, input metadata may specify specific attributes of a quantum processor, i.e., a specific type of quantum device for which the quantum circuit should be adapted, or a specific type of transformation to be performed on the quantum circuit. The circuit depth and commuting sets within the quantum circuit are both examples of metadata produced during the circuit transformation process.

A transformation operation may specify one or more transformations to be performed on a quantum circuit to reconfigure the circuit into a different, but equivalent, quantum circuit. In other words, a transformation reconfigures, for example, a gate in the first quantum circuit such that a qubit used in the gate complies with a constraint on the quantum circuit design. To do this, a transformation operation has read-only access to the metadata store, and write-only access to the stored representation of the quantum circuit.

For example, a particular quantum processor might have a restriction on which qubits are coupled together, and hence able to communicate, with certain other qubits. To adapt a circuit to this quantum processor, a transformation operation may redistribute gates into different portions of a quantum circuit.

Reducing the number of gates in a quantum circuit may improve circuit efficiency. Thus, another example transformation operation may rearrange target and control inputs of gates, according to specific transformation rules, to remove redundant gates from a quantum circuit.

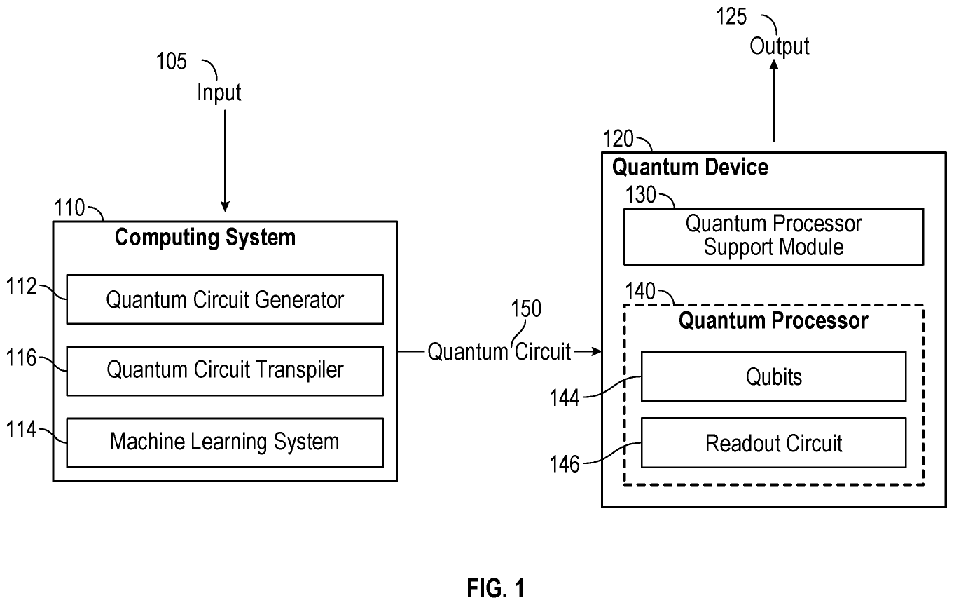

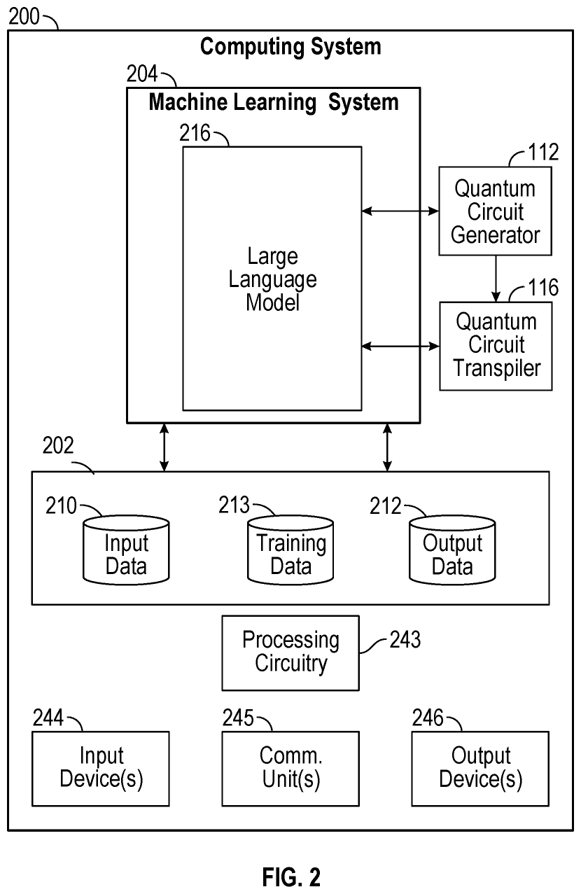

With reference to the figures and in particular with reference to FIGS. 1 and 2, these figures are example diagrams of computing environments in which the disclosed techniques may be implemented. FIGS. 1 and 2 are only examples and are not intended to assert or imply any limitation with regard to the environments in which different disclosed techniques may be implemented. A particular implementation may make many modifications to the depicted environments based on the following description.

FIG. 1 depicts a block diagram of an example configuration for quantum circuit transpiling using LLMs, and execution of the optimized quantum circuit, in accordance with the techniques of the disclosure. Classical computing environment 110 may comprise, for example, a server. Quantum device 120 may include one or more quantum processors 140. Each of quantum processors 140 may be a qubit 144, for example.

Within conventional computing system 110, quantum circuit generator 112 may generate a plurality of quantum circuits that conform to a general quantum circuit design language to train a machine learning model of machine learning system 114. Quantum circuit transpiler 116 may transpile each of the one or more quantum circuits into a different but equivalent quantum circuit to generate labeled (ground truth) data for training purposes, as described below. In some examples, quantum circuit transpiler 116 may represent a third-party transpiler program. Once machine learning system 114 is trained to transpile quantum circuits, machine learning system 114 may be deployed to perform transpiling based on the input 105 and to generate one or more transpiled quantum circuits 150 for other quantum circuits that conform to the general quantum circuit design language. In some use cases, machine learning system 114 may replace quantum circuit transpiler 116. Machine learning-based optimization could significantly reduce transpilation times, especially for larger circuits, and could pave the way for larger, more complex quantum computations, as described below. In an aspect, input 105 may include, but is not limited to, information related to constraints of a target quantum device, one or more machine learning parameters, etc.

In the context of quantum computing, a term “target quantum device” refers to a specific piece of quantum hardware that a quantum circuit is intended to run on. Quantum device 120 is the physical machine that performs quantum computations. As shown in FIG. 1, quantum device 120 may include qubits 144 (quantum bits), which are the basic unit of information, and control systems (e.g. quantum processor 140) to manipulate them. Transpiled quantum circuit 150 may be adapted specifically for this particular quantum device 120. Currently, there is a lot of variation in how quantum devices are built. Different quantum devices 120 may have: varying numbers of qubits 144, different capabilities for performing specific quantum operations (gates), unique limitations, such as, but not limited to, error rates or connectivity between qubits 144. Examples of quantum device 120 include, but are not limited to: superconducting qubits, trapped ion qubits, and photonic qubits. Superconducting qubits are a common type of quantum device 120 where qubits 144 are encoded in the electrical properties of superconductors. In trapped ion qubits type, qubits 144 are encoded in the state of trapped ions (charged atoms). In photonic qubits type of quantum device 120, light particles (photons) are used to represent qubits 144. Accordingly, within quantum device 120, quantum processor 140, including qubits 144 and readout circuit 146, may execute the transpiled quantum circuit 150. Quantum device 120 may also include quantum processor support module 130, which may output the results of executing the quantum circuit 150 as output 125. In an aspect, output 125 may be a solution to a problem the quantum circuit 150 is designed to solve.

Quantum device 120 may receive quantum circuit 150 generated by computing system 110 via one or more of a wired or wireless network, a portable storage device, manual entry via a user interface, or machine-to-machine communication via an interface, for instance. In an aspect, quantum device 120 may also receive quantum state of qubits 144 as input. Such input is optional and not shown in FIG. 1. Quantum states are described in greater detail above.

In summary, quantum circuit generator 112 may create a first plurality of initial quantum circuits. Each of the first plurality of quantum circuits may comprise a sequence of instructions. These instructions may include the gates used (e.g., Hadamard or CNOT gates) and any operations performed on those gates (e.g. rotations). These circuits may be described in a general quantum circuit design language. Such general quantum circuit design language is hardware agnostic. In other words, the first plurality of quantum circuits may use standard instructions for gates and operations, independent of a specific hardware setup. Examples of the general quantum circuit design language include, but are not limited to, Qantum Assembly Language (QASM), OpenQASM, Qwire, QHDL, CIRQ, Quipper, and Qiskit. Each circuit in the first plurality of quantum circuits may perform a different function, but they all may share the same basic language for describing the steps. Each circuit from the first plurality may undergo a process called transpilation. Transpilation may essentially translate the circuit from the general quantum circuit design language to a specific set of instructions compatible with a particular target quantum device (e.g., IBM Quantum Manhattan). Different devices have different capabilities, so the original circuit might need adjustments to work on the target hardware. In one implementation quantum circuit transpiler 116 may transpile the first plurality of initial quantum circuits. In alternative implementation, computing system 110 may obtain a second plurality of quantum circuits (transpiled first plurality of quantum circuits) from a third party tool (e.g., Qiskit). Computing system 110 may use both the original circuits (first plurality) and their transpiled versions (second plurality) to train a machine learning model of machine learning system 114. By feeding the model these paired examples, the machine learning model can learn the relationship between the general design language and the specific instructions needed for the target device. The ultimate goal of the training is to create a machine learning model that may efficiently transpile any new quantum circuit written in the general language (e.g., input 105) to work on the target quantum device. Traditionally, transpilation may be a complex and time-consuming process. By training a machine learning model, computing system 110 may automate this task for future quantum circuits, saving time and effort. The machine learning model may potentially learn from a vast amount of data, leading to more efficient transpilations compared to manual approaches.

While described with respect to a particular set of large learning models, the techniques of this disclosure may be applied to analyze and transpile quantum circuits in a variety of applications, such as, but not limited to, computational chemistry, logistics, finance, traffic optimization, cryptography, and others.

FIG. 2 is a block diagram illustrating an example computing system 200. In an aspect, computing system 200 may represent classical computing environment, such as computing system 110 shown in FIG. 1. As shown, computing system 200 includes processing circuitry 243 and memory 202 for executing a machine learning system 204 having LLM 216, quantum circuit generator 112, and quantum circuit transpiler 116. In an aspect, machine learning system 204 may represent machine learning system 114 shown in FIG. 1. Although shown as part of a common computing system 200, either or both of quantum circuit generator 112 or quantum circuit transpiler 116 may be implemented on a system separate from the LLM 216.

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent cloud computing system, a server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., LLM 216), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute machine learning system 204 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, machine learning system 204 may receive input data from an input data set 210 and may generate output data 212. Input data 210 and output data 212 may contain various types of information, which will generally be tailored to the application/use case for the quantum computing environment. When used in the example system of FIG. 1, input data 210 may include symbolic representations of one or more quantum circuits to transpile, specific limitations of target devices to which quantum circuits are to be transpiled, or identifiers for target devices to which quantum circuits are to be transpiled, for example. Output data 212 may include information such as, but not limited to (i) transpiled quantum circuit(s) and (ii) the results of executing the transpiled quantum circuit.

Machine learning system 204 may process training data 213 to train the LLM 216, in accordance with techniques described herein. For example, machine learning system 204 may apply an end-to-end training method that includes processing training data 213. Training data 213 may include, but is not limited to, any symbolic representation of quantum circuits (the theoretical design) generated by quantum circuit generator 112. In one example, machine learning system 204 may process one or more quantum circuits generated by quantum circuit generator 112 with quantum circuit transpiler 116 to generate labeled training data 213. Labeling training data 213 may include tagging each transpiled circuit quantum with information about the specific device that transpiled circuit is compatible with. The LLM 216 being trained needs to understand the relationship between the original general quantum circuit (generated by the quantum circuit generator 112) and its transpiled version for the target device (quantum circuits transpiled by quantum circuit transpiler 116). By labeling each transpiled circuit with the target device identifier, LLM 216 may learn how the general instructions are transformed based on the capabilities and limitations of different hardware. It should be noted that machine learning system 204 may start training the LLM 216 on a dataset that starts with smaller, well-understood circuits, which may allow the LLM 216 to grasp the fundamental building blocks of efficient quantum circuits before tackling more intricate problems, as described in greater detail below. Once trained, LLM models may be deployed to process input data 210.

The field of quantum computing is rapidly evolving, leading to a wide variety of quantum devices being developed. This diversity is positive for the advancement of the technology, but the diversity also creates a challenge. Qiskit is a non-limiting example of an open-source quantum computing framework. Qiskit offers access to 47 different quantum backends, each representing a specific type of quantum device. The diversity of quantum devices is likely to increase in the future due to growing interest from academia, industry, and government.

There are many different types of quantum devices, each with its own limitations. As noted above, these limitations may include, but are not limited to the number of qubits (quantum bits) the device may handle and the specific set of quantum gates (basic operations) the device may perform. The 47 backends of Qiskit mentioned earlier highlight this variety—each backend represents a different quantum device with different, sometimes capabilities. Developers may design quantum circuits using a broad range of theoretical quantum operations, representing the ideal scenario. The “alphabet” of operations may encompass a wider range of possibilities than what any current device may actually execute. The challenge arises in bridging the gap between the general design and the specific device. Transpilation is the process of converting a general quantum circuit, according to a general quantum circuit design language, into a quantum circuit that is compatible with limitations of a particular device. Transpilation may involve finding equivalent sequences of gates that the device can actually perform to achieve the same overall goal as the original quantum circuit. Transpilation may be computationally expensive, especially for complex quantum circuits or quantum devices with very limited capabilities. Finding efficient ways to translate a circuit while maintaining functionality of the quantum circuit may be time-consuming.

Currently, transpilers rely on rule-based systems and heuristic algorithms like genetic algorithms and ant colony optimization. Such optimization approaches work by iteratively applying pre-defined rules or mimicking natural processes to find an acceptable solution. These approaches may be slow, especially for complex quantum circuits. Furthermore, current optimization approaches do not inherently learn from previous optimizations, often requiring significant time for each new circuit. As quantum computers get bigger and circuits become more intricate, transpilation times using these approaches could become a major bottleneck, hindering the overall performance and practicality of quantum computation.

While transpiling small quantum circuits may only take seconds or minutes, the cost may increase significantly for complex scenarios because complex quantum circuits may have larger number of operations and larger number of qubits. Larger number of operations may mean that more quantum gates may be involved in the quantum circuit. The complex quantum circuit may use a greater number of qubits, which may increase the number of possible combinations and interactions that need to be considered during transpilation.

For example, IBMQ Manhattan backend has 65 qubits, which is a relatively high number compared to some other quantum devices.

Reordering operations and swapping qubits to fit device connectivity constraints may be a combinatorial optimization problem. In other words, the number of possible transpilation solutions may grow exponentially with the quantum circuit size. Quantum circuit transpiler 116 may need to trade-off the depth (number of gate layers) and width (number of qubits used concurrently) of the input quantum circuit to optimize the output quantum circuit 150 for the capabilities of the specific quantum device.

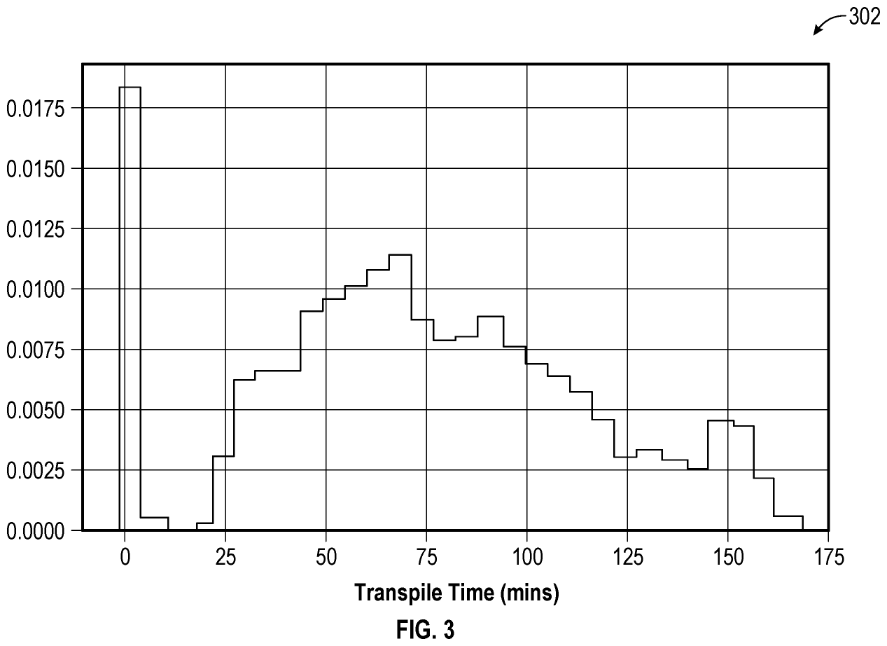

FIG. 3 is a histogram illustrating transpilation times for a specific quantum computing machine, in accordance with the techniques of the disclosure. FIG. 3 is a graphical representation (histogram 302) of how often different transpilation times occur. The histogram 302 using a plurality of quantum circuits randomly generated by quantum circuit generator 212 using a technique that captures all possible combinations of classical and quantum gates. FIG. 3 illustrates the impact of quantum circuit complexity on transpilation times in a broader sense.

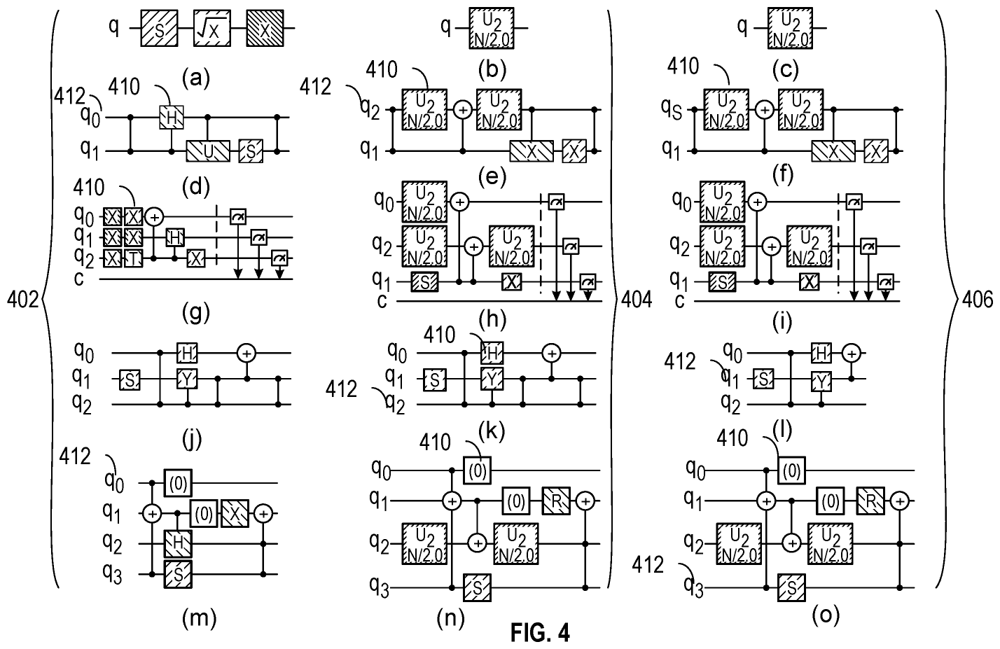

In quantum computing, circuit complexity refers to the difficulty of implementing a quantum algorithm using a quantum circuit. Two key factors that contribute to the quantum circuit complexity are: number of qubits and number of gates. As noted above, qubits are the quantum equivalent of bits in classical computers. Qubits may exist in a superposition state, representing both 0 and 1 simultaneously. Generally, the more qubits involved in a circuit, the more complex the quantum circuit becomes because the number of possible states may grow exponentially with the number of qubits. Manipulating and controlling the states may become increasingly challenging with more qubits. Quantum gates are the basic building blocks of quantum circuits. Quantum gates perform operations on qubits, such as rotations, flips, and entanglements. The number of gates in a circuit (such as input quantum circuit 402 shown in FIG. 4) may also impact complexity of the quantum circuit. Each gate may add another layer of operation, potentially increasing the time and resources required to execute the quantum circuit.

Quantum circuits with few qubits and gates are generally easier to implement and require less time on a quantum computer. As the number of qubits and gates increases, the circuit complexity may rise dramatically. Complex quantum circuits may lead to longer execution times and higher error rates due to the increased difficulty of maintaining qubit coherence.

Breaking down complex gates into simpler ones may reduce the overall gate count. Identifying redundant operations and eliminating them may streamline the quantum circuit. Quantum error correction codes may help mitigate errors that arise during longer, more complex circuits. During transpilation, a transpiler may analyze the original circuits (e.g., quantum circuit 402) to identify operations that are redundant. An operation may be considered redundant if that operation does not contribute to the final output of the quantum circuit. There are two main types of redundancies: unnecessary gates and redundant subcircuits. The unnecessary gates are gates that could be removed without affecting the overall outcome of the quantum circuit. For example, applying a Hadamard gate followed by another Hadamard gate on the same qubit cancels itself out. Sometimes, a sequence of gates within a quantum circuit may be performing the same function as another sequence elsewhere in the quantum circuit. Identifying and eliminating these redundant subcircuits may simplify the overall structure. Once redundant operations are identified, they may be removed from the transpiled circuits (e.g., quantum circuit 406). Eliminating redundant operations from the sequence may free up qubits and gates, allowing more complex computations to be performed on the same quantum device.

Furthermore, during transpilation, a transpiler may attempt to reduce the number of gates used. This reduction can be achieved in several ways: gate decomposition, gate substitution and algebraic simplification. Certain complex gates may be equivalent to combinations of simpler gates. For example, a controlled-NOT (CNOT) gate may be decomposed into a series of Hadamard, CNOT, and Pauli-X gates. By replacing complex gates with simpler decompositions, the overall gate count may be reduced. Sometimes, specific gates may not be natively supported by the target quantum device. The transpilation process may identify alternative sequences of gates that may achieve the same functionality using only supported gates on the target quantum device. Such substitution may help ensure the transpiled circuit may be executed while potentially reducing the overall gate count. In some cases, applying certain gate sequences may cancel each other out, effectively reducing the number of gates needed. The transpilation process may employ techniques from quantum circuit algebra to identify such simplifications. Fewer gates generally translate to a lower circuit depth, leading to faster execution on quantum devices due to reduced error accumulation. Reducing gates, just like eliminating redundant operations, may free up qubits that were previously occupied, allowing for more complex computations to be performed on the same quantum device. With fewer gates, there are fewer opportunities for errors to occur during execution.

While some quantum circuits may be transpiled (converted for a specific device) relatively quickly, most circuits may take a significantly longer time. In the example of FIG. 3, histogram 302 was generated based on the analysis of 5075 quantum circuits and the corresponding transpilation times.

The average (mean) transpilation time in histogram 302 is 74 minutes. The median transpilation time is 72 minutes. These statistics indicate that a large portion of the circuits took a long time to transpile. Generally, the median being close to the mean may suggest the distribution of times may be symmetrical, with many circuits taking around the average time. Due to the lengthy transpilation times, designing new quantum circuits may incur a significant time cost.

The time cost is likely to increase for at least two reasons: deeper circuits and more qubits. As quantum algorithms become more complex, the quantum circuits used to implement them will likely involve more operations (gates) and become “deeper.” As quantum devices with a larger number of qubits become available, developers may design circuits that exploit this increased capacity, further adding to their complexity.

FIG. 4 illustrates examples of a plurality of machine-learning transpiled quantum circuits matching the corresponding quantum circuits transpiled using conventional approaches, in accordance with the techniques of the disclosure. As noted above, the disclosed machine learning system 204 may reduce the transpilation cost by using one or more LLMs 216. LLMs 216 have proven successful in tasks like natural language translation and code completion, which involve understanding complex relationships within sequences.

In an example, LLM 216 may be a transformer-based model. LLM 216 may include multiple layers of transformer blocks stacked on top of each other. Each transformer block contains multiple self-attention layers and feedforward neural network layers. The depth of this model contributes to its ability to capture complex patterns and relationships in the input data. LLM 216 trained as disclosed herein is suitable for transpiling.

LLM 216 may be specifically designed for transpilation. Transformer-based architectures are specifically designed for sequence-to-sequence tasks and therefore excel at understanding/modeling long-range dependencies in sequences of operations. Such architectures may be crucial for LLMs 216 because quantum algorithms or various representations of quantum circuits may involve complex relationships between different parts. Transformers are known for their efficient processing of large amounts of data. Large amounts of training data are important for training LLMs 216 that need to handle vast amounts of information to learn effectively. LLM 216 may be pre-trained on large corpora of circuit data using unsupervised learning techniques, such as masked language modeling or autoregressive language modeling. After pre-training, LLM 216 can be fine-tuned on task-specific data, such as training data 213, using supervised learning to adapt LLM 216 to the specific task of transpiling. The transformer architecture may be versatile and may be adapted to different tasks beyond natural language processing. For instance, with modifications to a conventional LLM, LLM 216 may be used to process the sequential representations of quantum circuits. In an example, LLM 216 may have an encoder-decoder structure. The encoder-decoder structure may allow the LLM 216 to learn the relationships between different parts of a sequence (e.g., an algorithm description) and then generate a corresponding output (e.g., a quantum circuit representation). Self-attention mechanism may enable the LLM 216 to focus on the most relevant parts of the input sequence, understanding how different elements relate to each other. Self-attention mechanism may be important for capturing the intricacies of quantum circuits. LLM 216 may process quantum circuits as diagrams (e.g., images), or as data structures of sequences.

For LLM 216 training purposes, machine learning system 204 may employ quantum circuit generator 112. LLM 216 may be trained to take any symbolic representation of a quantum circuit (the theoretical design) and may directly transpile it to a desired quantum computing device (target device), considering the limitations of the target device. An important aspect is ensuring the transpiled circuit adheres to the specific limitations of the target device.

Advantageously, LLM 216 introduces a data-driven approach to transpilation. LLMs 216, particularly those based on transformer networks, typically excel at understanding sequential data. Quantum circuits may be naturally represented as sequences of gates and operations, making them a perfect fit for LLM model 216.

In quantum computing, a quantum circuit represents a sequence (series of operations performed on qubits). To leverage LLM 216 for transpilation, machine learning system 204 may need to transform quantum circuits (e.g., quantum circuits generated by quantum circuit generator 112) into sequences suitable for the input format into LLM 216. For example, machine learning system 204 may map each qubit in the quantum circuit to a separate line or item in the sequence. Each gate applied to a qubit at a specific point in the quantum circuit may be represented by a unique token in the corresponding line of the qubit within the sequence. The order of gates in the quantum circuit needs to be strictly preserved in the sequence. Gates are applied sequentially, so the order dictates the flow of operations on each qubit. As a non-limiting and simplified example, a simple quantum circuit with two qubits (q₀ and q₁) and two gates: a Hadamard gate (H) applied to q₀ and a Controlled NOT (CNOT) gate where q₀ controls q₁ may be represented as the following sequence:
q₀: H#Hadamard gate on q₀
q₁: _#Empty token, no gate applied at this point
q₀: _#Empty token, no further operation on q₀ after H
q₁: CNOT (q₀) #CNOT controlled by q₀ on q₁

The sequence above captures the essence of the corresponding quantum circuit—the qubits involved and the gates applied to them in the correct order. Empty tokens may be used to represent places where no gate is applied at a specific point in the sequence for a particular qubit. The LLM 216 may process this sequence and understand the relationships between gates and qubits, allowing it to analyze and potentially optimize the quantum circuit. The sequence retains all the important information about the quantum circuit, including the qubits and the operations performed on them. By representing quantum circuits as sequences, machine learning system 304 may train LLM 216 to identify patterns, redundancies, and potential optimizations within the quantum circuit structure.

FIG. 4 illustrates a first plurality of input quantum circuits 402 that may be generated by quantum circuit generator 112, a second plurality of quantum circuits 404 transpiled by LLM 216 and a third plurality of quantum circuits 406 that may be transpiled by conventional approaches, such as quantum circuit transpiler 116. As shown in FIG. 4, each of the quantum circuits 402-406 comprises a sequence of operations. Each quantum circuit lays out the steps to be performed on qubits (quantum bits) to achieve a desired outcome. These steps may involve applying various quantum gates 410 to the qubits 412 at specific moments. Quantum gates 410 are the basic building blocks of quantum circuits, and they act like operators that manipulate the quantum states of qubits 412. As shown in FIG. 4 the quantum circuits 404 transpiled by LLM 216 may match or be equivalent to the quantum circuits 406 transpiled by the quantum circuit transpiler 116. The equivalent quantum circuits are depicted by row. For example, item (a) of input quantum circuits 402 corresponds to item (b) of quantum circuits 404 and to item (c) of quantum circuits 406. In an aspect, LLM 216 may be trained on large datasets of optimized circuits and their properties. As a result of that training, LLM 216 may learn to identify efficient circuit structures and transformations. LLM 216 may potentially explore the optimization space much faster than traditional approaches (e.g., quantum circuit transpiler 116). Machine learning-based optimization could significantly reduce transpilation times, especially for larger circuits, and could pave the way for larger, more complex quantum computations.

Quantum circuits may vary greatly in complexity, ranging from a few qubits 412 and gates 410 to circuits with hundreds or even thousands qubits 412. Traditional training approaches might struggle to adapt a model to handle such a vast range of complexities efficiently. By training the LLM 216 on a vast amount of data containing optimized quantum circuits and their properties, the trained LLM 216 may essentially “learn the language” of quantum circuits. Such training may allow LLM 216 to identify patterns and relationships between circuit structures and their efficiency. Each quantum circuit may be broken down into its basic elements like gates 410 (Hadamard, CNOT, etc.) and their connections. The LLM 216 may be trained to recognize the basic elements and their relationships within the quantum circuit structure. With the training disclosed herein, LLM 216 may develop the ability to identify patterns and relationships within the quantum circuits. For example, LLM 216 may recognize frequently occurring sequences of gates (subcircuits) across different quantum circuits. Common subcircuits may indicate common building blocks used in various quantum algorithms. LLM 216 may learn how the placement and order of gates affect each other within a quantum circuit. This understanding of gate dependencies may be important for optimizing quantum circuit performance. If the quantum circuits involve parameters (variables that may be adjusted), LLM 216 might identify how changes in these parameters affect the overall quantum circuit structure and function.

LLM 216 may be viewed as an agent in a reinforcement learning environment. LLM 216 would receive rewards for generating efficient circuits and learn through trial and error to improve its performance over time.

LLM 216 may be trained to predict the quality of an input quantum circuit (e.g., quantum circuits 402a, 402d, 402g, 402j, 402m) or suggest optimal transformations based on the structure of the corresponding quantum circuit. The training data 213 for LLM 216 could include not just circuit structures but also examples of successful transformations applied to those circuits (e.g., second plurality of quantum circuits 404). These examples may involve how specific patterns were addressed to improve the performance of a quantum circuit on a target device. Based on the identified patterns, LLM 216 may recommend transformations that have been successful in similar situations within the training data 213. Such predictions could guide the search process towards better solutions. Machine learning models, especially complex ones like LLMs 216, thrive on vast amounts of training data 213. A randomized quantum circuit generator 112 allows to create the aforementioned training data 213 efficiently.

The training data 213 should encompass a wide range of circuit structures and complexities. The randomized quantum circuit generator 112 may ensure that the generated circuits represent a diverse set of problems, making LLM 216 more adaptable to real-world scenarios.

In an example, machine learning system 204 may start training LLM 216 on training dataset 213 with smaller, well-understood quantum circuits (e.g., quantum circuit 402a), which may allow the LLM model 216 to grasp the fundamental building blocks of efficient quantum circuits before tackling more intricate problems. As performance of the LLM 216 improves, machine learning system 204 may gradually introduce more complex circuits into the training data 213. This staged approach allows LLM 216 to progressively build its understanding of quantum circuit optimization.

It should be noted that the aforementioned staged learning technique, also known as curriculum learning technique, may allow LLM 216 to progressively build its understanding of quantum circuit optimization. In this case, the curriculum learning concept is applied to the training data 213 for the LLM 216. Starting with smaller (simpler) quantum circuits may allow LLM 216 to grasp the fundamental rules and relationships between gates and operations. The learned fundamental rules and relationships may build a solid foundation for understanding more intricate circuits later. In other words, as LLM 216 progresses through the training curriculum, LLM 216 may leverage the rules and relationships learned from simpler circuits to understand and optimize more complex ones.

In an example, machine learning system 204 may identify simpler circuits using a simplicity threshold. As used herein, the term “simplicity threshold” refers to a set of criteria used to identify “simple” quantum circuits. Quantum circuits that meet this criteria may be considered easier to transpile and may be used for initial training of the LLM 216. Quantum circuits with fewer qubits 412 may be generally considered simpler because such circuits may require fewer interactions and manipulations. A simplicity threshold may be set on the maximum number of qubits 412 allowed in a “simple” circuit for training purposes. Quantum circuits with a lower number of gates may also be considered simpler because they involve fewer operations and potentially less entanglement. The simplicity threshold could be set on the maximum number of gates 410 allowed in a “simple” circuit. Often, the simplicity threshold may consider both the number of qubits 412 and the number of gates 410. For example, a simplicity threshold may be defined as quantum circuits with less than 5 qubits 412 and less than 10 gates 410. By starting with simpler circuits, the LLM 216 may focus on understanding the fundamental aspects of transpilation for a specific device. Such focus may help LLM 216 to build a strong foundation for learning more complex quantum circuits later. Simpler quantum circuits may require less computational resources to process and transpile. Accordingly, simpler quantum circuits may allow for faster training of the LLM 216. Studying how LLM 216 transpiles simpler circuits may provide insights into its decision-making process, which may be helpful for debugging and improvement.

Beyond employing random quantum circuit generator 116, machine learning system 204 may use data augmentation techniques to artificially expand the training dataset 213. In an example, data augmentation techniques may involve introducing controlled variations or errors into existing quantum circuits to create a richer learning environment for LLM 216. While randomization is important, it may be also beneficial for machine learning system 204 to incorporate some quantum circuits that resemble those encountered in practical applications. Focus on realistic quantum circuits may help LLM 216 generalize its knowledge to real-world problems. By progressively introducing quantum circuits with more qubits and complexities, LLM 216 learns to generalize the acquired knowledge. The improved generalization may enable LLM 216 to apply the learned concepts from simpler circuits to solve more challenging problems.

Curriculum learning may potentially lead to faster training times and more accurate results compared to throwing all complexities at LLM 216 from the beginning. The LLM model 216 may learn incrementally, avoiding getting overwhelmed by intricate structures before LLM 216 has a grasp of the basics.

In summary, quantum algorithms are often described using circuit diagrams. The circuit diagrams visually represent the sequence of gate operations needed to execute the quantum algorithm. Each gate 410 in the quantum circuit may act on specific qubits 412 or classical bits. The circuit diagram is read from left to right, indicating the order of operations. While circuit diagrams are helpful for understanding quantum algorithms, real quantum devices may have limitations. Not all theoretical quantum gates 412 may be directly implemented on the specific quantum devices due to hardware constraints. To bridge the aforementioned gap, transpilers may come into play. Transpilers (e.g., quantum circuit transpiler 116) are specialized software tools that transform quantum circuits. Transpilers may take a quantum circuit designed using any available gate and may convert the quantum circuit into a form compatible with the specific hardware limitations of the target quantum device 120. Transpiling may be computationally expensive, especially for complex circuits with many qubits or intricate operations.

The disclosed machine learning system 204 may use LLM 216, a type of deep learning model typically trained on natural languages. Generally, LLMs excel at understanding and manipulating sequences. Quantum circuits may be represented as sequences of gates and operations. By training LLM 216 on a vast amount of training data 213 containing, for example, original quantum circuits 402 and their transpiled equivalents (e.g., quantum circuits 406) for a specific target device, machine learning system 204 enables LLM 316 to essentially “translate” between these circuit representations. Each transpiled circuit (quantum circuit 406) produces the same output as its corresponding original circuit (quantum circuit 402). This ensures that the transpilation process does not alter the intended function of the quantum circuit. Each transpiled circuit (quantum circuit 406) may outperform its corresponding original circuit (quantum circuit 402) in some way. This improvement, also referred to herein as “better performance,” may refer to several factors depending on the context: reduced depth, fewer qubits, gate fidelity, runtime. The transpiled circuit may have a lower depth (number of gate layers). Reduced depth may be desirable because deeper quantum circuits may take longer to execute on real quantum devices due to increased error accumulation. The transpiled circuit 404 may use fewer qubits 412 than the original circuit 402. Fewer qubits 412 may be important because quantum devices have a limited number of qubits 412, and using fewer qubits allows for more complex computations to fit on the quantum device. The transpiled circuit 404 may use gates 410 that the target device 120 may execute more accurately, leading to fewer errors in the final result. The transpiled circuit 404 may execute faster on the target quantum device 120 due to optimizations made during transpilation. Transpilation is like adapting an original recipe (original quantum circuit) for a new oven (target device). The new recipe (transpiled circuit) may use different ingredients (gates) or steps (ordering of operations) but should still result in the same delicious cake (equivalent output). However, the new recipe may be better suited to the oven (performs better), perhaps using less time or fewer ingredients (improved performance metrics).

The curriculum learning means that the LLM 216 may be trained progressively, starting with simpler quantum circuits and gradually increasing complexity. Curriculum learning allows LLM 216 to build a strong foundation in understanding basic transpilation rules before tackling more intricate quantum circuits. LLMs, with their ability to analyze vast amounts of data quickly, have the potential to significantly reduce transpilation times compared to traditional approaches. By leveraging machine learning, the disclosed techniques could lead to a more efficient transpilation process, reducing the computational resources required.

With increased attention from academia, industry, and government, the diversity of quantum devices is expected to surge in the coming years. Qiskit is a popular open-source framework for quantum computing. Qiskit provides access to various quantum backends (simulators or real devices) with different capabilities. Currently, Qiskit offers 47 backends, each with specific limitations on the number of qubits and the types of gates the framework can handle. Developers may design quantum circuits using a broad set of theoretical gates, representing the ideal quantum algorithm. Such representation is like having a universal “alphabet” of quantum operations. The challenge arises when translating such general quantum circuits into a form compatible with limitations (e.g., number of qubits, available gates) of a specific quantum device. This process is called transpilation. Transpilation may be computationally expensive, especially for complex circuits. As a non-limiting example, a 127-qubit circuit may take 6 hours to transpile.

Conventional transpilation tools typically rely on pre-defined rules and heuristic algorithms like genetic algorithms and ant colony optimization. Conventional approaches work by iteratively applying these rules or mimicking natural processes to find a quantum circuit that meets certain criteria, like minimizing the number of gates or depth of the quantum circuit. Such time-consuming process may be a significant bottleneck, as transpilation times may become lengthy. Conventional approaches do not leverage the power of data or machine learning. Instead, the conventional approaches rely solely on pre-defined rules, which may not always be the most efficient approach for complex scenarios. As quantum computers become more powerful, with a larger number of qubits, the complexity of circuits will also increase. This increase could further exacerbate the limitations of traditional transpilation approaches.

The disclosed techniques replace the transpilation approaches (e.g., quantum circuit transpiler 116) with LLM 216-a powerful type of deep learning model skilled at processing sequences. Quantum circuits may be naturally represented as sequences of gates and operations, making them a perfect fit for LLM 216 input. Training LLM 216 effectively may require a vast amount of data. The disclosed machine learning system 204 addresses this issue by using a large randomized quantum circuit generator 112. The randomized quantum circuit generator 112 may create a diverse dataset of quantum circuits with varying complexities, providing LLM 216 with a broad range of scenarios to learn from. Curriculum learning may allow LLM 216 to grasp the fundamentals before progressing to more intricate quantum circuits with a larger number of qubits 412. Gradually increasing the complexity may help LLM 216 build upon its knowledge and may help develop a more comprehensive understanding of transpilation. Machine learning system 204 tackles a critical bottleneck in quantum computing by proposing a potentially faster and more efficient transpilation method. By combining LLM 216 with a curriculum learning technique and a large, diverse training dataset 213, the disclosed machine learning system 204 may have the potential to significantly accelerate the development and execution of complex quantum algorithms.

As noted above, traditionally, transpilation may be slow, especially for complex circuits. LLMs, with their ability to analyze data quickly, may significantly speed up this process. The disclosed machine learning system 204 may also improve the quality of the output quantum circuit(s) 404 by increasing fidelity of the corresponding quantum circuit (how well the quantum circuit performs the desired task). Increased fidelity may be important for accurate computations. Faster transpilation may be particularly advantageous for hybrid quantum algorithms. Hybrid quantum algorithms may involve a back-and-forth loop between classical and quantum computations, and faster transpilation would improve their efficiency. As quantum computers become more powerful, with a larger number of qubits and the ability to handle more complex circuits, faster transpilation methods described herein may become important. It should be noted that there is a growing trend of quantum devices becoming available on cloud platforms. The rise of cloud quantum services allows users to access and run quantum computations without owning the physical hardware. To offer a complete service, cloud providers may need to provide tools for compiling (optimizing) and transpiling (converting) quantum circuits for their specific devices. Traditionally, building the transpiling tools may involve manual coding, which may be expensive and time-consuming. In an example, the disclosed machine learning system 204 may use LLM 216 for transpilation. LLM 216 may be trained much faster than manually coding traditional transpilers. The machine learning system 204 has the potential to produce transpiled quantum circuits with higher fidelity. In other words, the quantum circuits transpiled by LLM 216 may perform the desired task more accurately. By adopting the disclosed LLM-based transpilation system, cloud service providers may avoid the expensive process of manually building transpilers for each device. Faster transpilation times may translate to quicker turnaround for users running quantum computations on their cloud platform. The Computer Aid Design (CAD) industry often uses simulations to design and test new products. Cloud services with faster and more efficient transpilation tools implementing the disclosed techniques may be important for the CAD industry to leverage the power of quantum computing for design and development.

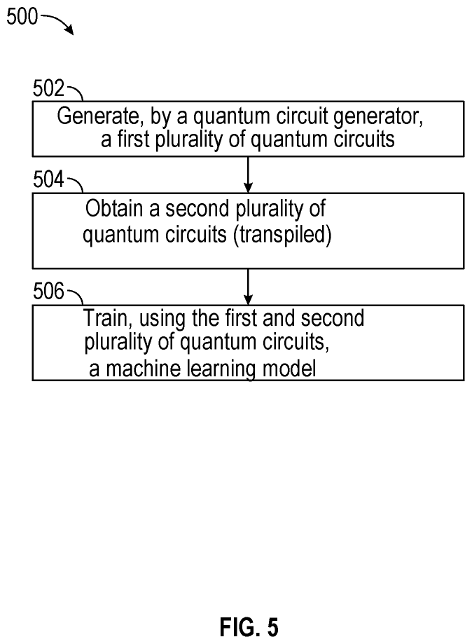

FIG. 5 is a flowchart illustrating an example mode of operation for a machine learning system, according to techniques described in this disclosure. Although described with respect to computing system 200 of FIG. 2 having processing circuitry 243 that executes machine learning system 204, mode of operation 500 may be performed by a computation system with respect to other examples of machine learning systems described herein. In mode operation 500, processing circuitry 243 executes machine learning system 204. Quantum circuit generator 112 may generate a first plurality of quantum circuits according to a general quantum circuit design language (502). Each of the first plurality of quantum circuits may include a sequence of instructions comprising one or more gates and one or more gate operations. Next, machine learning system 204 may obtain a second plurality of quantum circuits. Each of the second plurality of quantum circuits may be transpiled for a target quantum device from a corresponding one of the first plurality of quantum circuits (504). In an example, quantum circuit transpiler 216 may transpile the first plurality of quantum circuits to generate the second plurality of quantum circuits. Furthermore, machine learning system 204 may train, using the first plurality of quantum circuits and the second plurality of quantum circuits, a machine learning model to transpile a quantum circuit according to the general quantum circuit design language to a quantum circuit for the target quantum device. In simpler terms, the disclosed method creates a training dataset with example quantum circuits, their corresponding instructions, and the desired optimized versions for a specific quantum device. The machine learning model may then learn from the aforementioned data to automatically perform transpilation for future quantum circuits on the same quantum device.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for training a machine learning model to transpile quantum circuits, the method comprising:
generating, by a quantum circuit generator, a first plurality of quantum circuits according to a general quantum circuit design language, wherein each of the first plurality of quantum circuits comprises a sequence of instructions comprising one or more gates and one or more gate operations;
obtaining a second plurality of quantum circuits, wherein each of the second plurality of quantum circuits is transpiled for a target quantum device from a corresponding one of the first plurality of quantum circuits; and
training, using the first plurality of quantum circuits and the second plurality of quantum circuits, a machine learning model to transpile a quantum circuit according to the general quantum circuit design language to a quantum circuit for the target quantum device.

2. The method of claim 1, wherein the second plurality of quantum circuits comprises the first plurality of quantum circuits converted into a form compatible with specific hardware limitations of the target quantum device.

3. The method of claim 1, wherein training a machine learning model further comprises training the machine learning model using one or more curriculum learning techniques.

4. The method of claim 3, further comprising:
selecting a subset of the first plurality of quantum circuits that satisfy a simplicity threshold,
wherein training the machine learning model comprises training, starting with the subset of the first plurality of quantum circuits that satisfy the simplicity threshold.

5. The method of claim 4, further comprising:
determining the simplicity threshold based on a number of qubits and/or a number of the one or more gates.

6. The method of claim 1, wherein the second plurality of quantum circuits are labeled with an identifier for the target quantum device.

7. The method of claim 1, wherein the machine learning model comprises a Large Language Model (LLM).

8. The method of claim 7, wherein the LLM has a transformer-based data model architecture.

9. The method of claim 8, wherein the LLM is trained to identify patterns and relationships between a plurality of circuit structures in the first plurality of quantum circuits.

10. The method of claim 1, wherein transpiling the first plurality of quantum circuits comprises:
identifying one or more redundant operations in the first plurality of quantum circuits; and
eliminating the identified one or more redundant operations from the second plurality of quantum circuits.

11. A method for transpiling a quantum circuit comprising:
obtaining a first quantum circuit generated according to a general quantum circuit design language;
obtaining specific hardware limitations of a target quantum device; and
transpiling, using a machine learning model trained to transpile a quantum circuit according to the general quantum circuit design language to a quantum circuit for the target quantum device, the first quantum circuit to a second quantum circuit for the target quantum device.

12. The method of claim 11, wherein the machine learning model is trained using one or more curriculum learning techniques.

13. The method of claim 12, further comprising:
training the machine learning model starting with a subset of a first plurality of quantum circuits that satisfy a simplicity threshold.

14. A computing system for training a machine learning model to transpile quantum circuits, the computing system comprising:
processing circuitry in communication with storage media, the processing circuitry configured to execute a machine learning system configured to:
generate, by a quantum circuit generator, a first plurality of quantum circuits according to a general quantum circuit design language, wherein each of the first plurality of quantum circuits comprises a sequence of instructions comprising one or more gates and one or more gate operations;
obtain a second plurality of quantum circuits, wherein each of the second plurality of quantum circuits is transpiled for a target quantum device from a corresponding one of the first plurality of quantum circuits; and
train, using the first plurality of quantum circuits and the second plurality of quantum circuits, a machine learning model to transpile a quantum circuit according to the general quantum circuit design language to a quantum circuit for the target quantum device.

15. The system of claim 14, wherein the second plurality of quantum circuits comprises the first plurality of quantum circuits converted into a form compatible with specific hardware limitations of the target quantum device.

16. The system of claim 13, wherein the machine learning system configured to train a machine learning model is further configured to:
train the machine learning model using one or more curriculum learning techniques.

17. The system of claim 16, wherein the machine learning system is further configured to:
select a subset of the first plurality of quantum circuits that satisfy a simplicity threshold,
wherein the machine learning system configured to train the machine learning model is further configured to train, starting with the subset of the first plurality of quantum circuits that satisfy the simplicity threshold, the machine learning model.

18. The system of claim 17, wherein the machine learning system is further configured to:
determine the simplicity threshold based on a number of qubits and/or a number of the one or more gates.

19. The system of claim 14, wherein the second plurality of quantum circuits are labeled with an identifier for the target quantum device.

20. The system of claim 14, wherein the machine learning model comprises a Large Language Model (LLM).

21. The system of claim 20, wherein the LLM has a transformer-based data model architecture.

22. The system of claim 21, wherein the LLM is trained to identify patterns and relationships between a plurality of circuit structures in the first plurality of quantum circuits.

23. A computing system for transpiling a quantum circuit, the computing system comprising:
processing circuitry in communication with storage media, the processing circuitry configured to execute a machine learning system configured to:
obtain a first quantum circuit generated according to a general quantum circuit design language;
obtain specific hardware limitations of a target quantum device; and
transpile, using a machine learning model trained to transpile a quantum circuit according to the general quantum circuit design language to a quantum circuit for the target quantum device, the first quantum circuit to a second quantum circuit for the target quantum device.

24. The system of claim 23, wherein the machine learning model is trained using one or more curriculum learning techniques.

25. The system of claim 24, wherein the machine learning system is further configured to:
train the machine learning model starting with a subset of a first plurality of quantum circuits that satisfy a simplicity threshold.

26. Non-transitory computer-readable storage media having instructions encoded thereon, the instructions configured to cause processing circuitry to:
obtain a first quantum circuit generated according to a general quantum circuit design language;
obtain specific hardware limitations of a target quantum device; and
transpile, using a machine learning model trained to transpile a quantum circuit according to the general quantum circuit design language to a quantum circuit for the target quantum device, the first quantum circuit to a second quantum circuit for the target quantum device.
